(19) United States
(12) Patent Application Publication
(10) Pub. No.: US 2010/0032260 A1
(43) Pub. Date: Feb. 11, 2010

(54) FRICTIONAL ENGAGEMENT DEVICE FOR AUTOMATIC TRANSMISSION

(75) Inventors: Terasu Harashima, Aichi-ken (JP); Shundo Yamaguchi, Aichi-ken (JP)

Correspondence Address: SUGHRUE MION, PLLC, 2100 PENNSYLVANIA AVENUE, N.W., SUITE 800, WASHINGTON, DC, 20037, US

(73) Assignee: TOYOTA JIDOSHA KABUSHIKI KAISHA, Toyota-shi (JP)

(21) Appl. No.: 12/441,041

(22) PCT Filed: Apr. 25, 2008
(86) PCT No.: PCT/IB08/01022

§ 371 Date: Mar. 12, 2009

(30) Foreign Application Priority Data
Apr. 26, 2007 (JP) 2007-116287

(51) Int. Cl. F16H 57/10

(52) U.S. Cl. 192/221

(57) ABSTRACT

A frictional engagement device for an automatic transmission includes a tubular case, a friction member on one side that is supported on the case, a friction member on the other side that is supported on a rotary element, an annular piston having a pressing portion that presses the friction members toward one axial side with a thrust force from a pressure receiving portion that defines an annular hydraulic chamber between it and the case, and plural return springs for urging the piston toward the other axial side. The piston has a first pressure receiving section where the pressing portion is cut out over a predetermined angular range, and a second pressure receiving section other than the first pressure receiving section. An urging force of the return springs per unit angular range of the first pressure receiving section is greater than an urging force of the return springs per unit angular range of the second pressure receiving section.

### BACKGROUND OF THE INVENTION

1. Field of the Invention

The present invention relates to a frictional engagement device for an automatic transmission mounted in a vehicle, in particular, a frictional engagement device for an automatic transmission which includes a piston whose friction-member pressing portion is partially cut out to prevent interference with another member.

2. Description of Related Art

In automatic transmissions mounted in an automobile, ring gears, planetary carriers, sun gears, and the like of plural planetary gear sets forming a gear change mechanism are selectively brought into frictional engagement with each other or selectively brought into frictional engagement with the case side by use of a wet multiplate clutch or brake as a frictional engagement device, thus shifting between power transmission paths so as to establish plural gear speeds.

As a frictional engagement device for an automatic transmission of this type, as described in, for example, Japanese Patent Application Publication No. 7-269663 (JP-A-7-269663), there is known a device including a drum that constructs a part of the power transmission path and has plural friction members on one side installed on its inner periphery, a friction member on the other side that is spline-coupled to another rotary element, a piston accommodated in the drum and having a pressing portion that presses the friction members on one side and on the other side into frictional engagement with each other, and plural return springs for urging the piston in a direction for releasing the frictional engagement between the friction members.

In this frictional engagement device, the pressing portion of the piston is formed in a continuous annular shape, and the plural return springs are arranged along the annular pressing portion at equal intervals in its circumferential direction.

However, the frictional engagement device for an automatic transmission according to the related art as described above has the following problems due to its construction in which the pressing portion of the piston is formed in a continuous annular shape, and the plural return springs are arranged along the annular pressing portion of the piston at equal circumferential intervals.

That is, due to the increasingly stringent demand for improved fuel efficiency in recent years, it has become necessary to mount a compact, multi-speed automatic transmission within a limited transmission-mounting space, and high-density arrangement of elements constructing the automatic transmission has thus become crucial. Accordingly, in order to prevent the piston of a frictional engagement device which has an annular pressing portion from interfering with another member such as a gear serving as an output element to the drive wheel side, it is necessary to form a cutout in the skirt-shaped annular pressing portion of the piston. Thus, in the case of a configuration in which plural return springs are arranged at equal circumferential intervals along the annular pressing portion of the piston, no reaction force is applied from the friction member side only at the portion of the cutout, making the piston constructed as a downsized element susceptible to deflection in the cutout area where only a hydraulic force acting in the pressing direction is applied. This may result in deformation of the piston.

### SUMMARY OF THE INVENTION

The present invention has been made in view of the problems described above. Accordingly, the present invention provides a frictional engagement device for an automatic transmission which is suitable for use in a compact, multi-speed automatic transmission, and which makes it possible to suppress deformation of a piston even when a cutout for preventing interference with another member is formed in the piston constructed as a downsized element.

Thus, according to an aspect of the present invention, there is provided a frictional engagement device for an automatic transmission, including: a tubular case provided inside the automatic transmission; a friction member on one side that is supported on the case; a friction member on the other side that is supported on a rotary element provided inside the automatic transmission; an annular piston slidably accommodated in the case and having a pressure receiving portion and a pressing portion, the pressure receiving portion defining an annular hydraulic chamber between the pressure receiving portion and the case, the pressing portion pressing the friction member on one side and the friction member on the other side toward one axial side with a thrust force from the pressure receiving portion; and plural return springs interposed between the case and the piston so as to urge the piston toward the other axial side, characterized in that the piston has a first pressure receiving section where the pressing portion is cut out over a predetermined angular range in its circumferential direction, and a second pressure receiving section other than the first pressure receiving section, and when the piston presses the friction member on one side and the friction member on the other side, an urging force of the return springs per unit angular range of the first pressure receiving section is greater than an urging force of the return springs per unit angular range of the second pressure receiving section.

In the second pressure receiving section, a hydraulic pressure from the hydraulic chamber side and a reaction force from the friction member side acting opposite thereto are applied to the piston, whereas in the first pressure receiving section where the pressing portion side of the piston is cut out, only the hydraulic pressure from the hydraulic pressure side is applied, making the pressure receiving portion in the first pressure receiving section susceptible to deformation such as deflection. However, according to the frictional engagement device for an automatic transmission as mentioned above, the urging force of the return springs per unit angular range in the first pressure receiving section becomes larger than that in the second pressure receiving section, thereby suppressing deformation of the pressure receiving portion in the first pressure receiving section. It should be noted that by setting the arrangement of the return springs in the second pressure receiving section as appropriate, the urging of the plural return springs as a whole can be set to a predetermined value, and also a moment that causes tilting of the piston can be suppressed.

In the frictional engagement device for an automatic transmission having the above-mentioned configuration, it is preferable that the number of the return springs arranged per unit angular range of the first pressure receiving section be larger than the number of the return springs arranged per unit angular range of the second pressure receiving section.

The urging force of the return springs per unit angular range can be thus easily made greater in the first pressure receiving section.

In the frictional engagement device for an automatic transmission having the above-mentioned configuration, it is preferable that when the piston presses the friction member on one side and the friction member on the other side, a generated load of the return springs within the first pressure receiving section be greater than a generated load of the return springs within the second pressure receiving section.

In this case, the urging force of the return springs per unit angular range of the first pressure receiving section can be made greater.

In the frictional engagement device for an automatic transmission mentioned above, a first return spring of the plural return springs which is arranged within the first pressure receiving section, and a second return spring of the plural return springs which is arranged within the second pressure receiving section may have mutually different spring constants.

According to the frictional engagement device for an automatic transmission as mentioned above, the urging force of the return springs per unit angular range of the first pressure receiving section can be increased gradually in accordance with an increase in the hydraulic pressure exerted on the pressure receiving section. This means that at the time of application of hydraulic pressure for frictional engagement when deformation is liable to occur in the first pressure receiving section, the urging force of the return springs can be sufficiently enhanced. Further, when the piston begins its stroke toward the frictional engagement side with the frictional engagement device in a released state, the urging force exerted by the plural return springs can be made substantially uniform across the entire circumference of the piston.

In the frictional engagement device for an automatic transmission mentioned above, a first return spring of the plural return springs which is arranged within the first pressure receiving section, and a second return spring of the plural return springs which is arranged within the second pressure receiving section may have the same spring constant and mutually different installation loads.

According to the frictional engagement device for an automatic transmission as mentioned above, the plural return springs can be formed as the same parts, thus allowing for ease of handling and reduced cost. Also, for example, if the material thickness on the back side of the pressure receiving portion is increased within the first pressure receiving section, the strength of the first pressure receiving section of the piston increases. Further, by making the installation load of the return springs large in the first pressure receiving section, the urging force of the return springs in the first pressure receiving section can be sufficiently enhanced.

In the frictional engagement device for an automatic transmission mentioned above, the return springs are preferably placed more densely at a central portion of the first pressure receiving section than at opposite ends of the first pressure receiving section in a circumferential direction of the piston.

According to the frictional engagement device for an automatic transmission as mentioned above, deflection of the pressure receiving section in the first pressure receiving section can be effectively suppressed.

It is desirable that the frictional engagement device for an automatic transmission mentioned above further include an annular retainer plate that retains one end of the plural return springs on its one side and is locked onto the case, and a recess into which the other end of the plural return springs retained by the retainer plate is fitted be formed on a back side of the pressure receiving portion of the piston.

According to the frictional engagement device for an automatic transmission as mentioned above, even when the arrangement intervals of the return springs are not uniform or the return springs used are of different kinds, its handling or assembling can be facilitated as the assembly having the plural return springs retained by the retainer plate.

In the frictional engagement device for an automatic transmission mentioned above, it is preferable that a depth of the recess provided on the back side of the pressure receiving portion of the piston be smaller in the first pressure receiving section than in the second pressure receiving section. Also, it is preferable that a surface of the retainer plate which retains the plural return springs be shaped so as to be closer to the return springs at a position corresponding to the first pressure receiving section than at a position corresponding to the second pressure receiving section.

According to the frictional engagement device for an automatic transmission as mentioned above, the return springs in the first pressure receiving section can be installed under greater deflection than the return springs in the second pressure receiving section. Since the installation load of the return springs in the first pressure receiving section can be thus made larger in advance, when the piston presses the friction member on one side and the friction member on the other side, the generated load of the return springs within the first pressure receiving section can be made greater than the generated load of the return springs within the second pressure receiving section. According to the piston and/or retainer plate shaped in this way, the generated load of the return springs in the first pressure receiving section can be made greater than the generated load of the return springs in the second pressure receiving section even if the return springs used in the first pressure receiving section and the return springs used in the second pressure receiving section have the same spring constant. Therefore, it is possible to effectively suppress deflection of the pressure receiving section in the first pressure receiving section of the piston.

According to the present invention, in the piston to which a hydraulic pressure from the hydraulic chamber side and a reaction force from the friction member side acting opposite thereto are applied in the second pressure receiving section, and only the hydraulic pressure from the hydraulic chamber side is applied in the first pressure receiving section where the pressing portion side is cut out, the urging force of the return springs per unit angular range in the first pressure receiving section is made greater than that in the second pressure receiving section to suppress deformation of the pressure receiving portion in the first pressure receiving section. It is thus possible to effectively suppress deformation of the piston, such as deflection of the pressure receiving portion in the first pressure receiving section.

### BRIEF DESCRIPTION OF THE DRAWINGS

The features, advantages, and technical and industrial significance of this invention will be better understood by reading the following detailed description of preferred embodiments of the invention, when considered in connection with the accompanying drawings, in which:

FIG. 1 is a schematic cross-sectional view showing a frictional engagement device for an automatic transmission according to a first embodiment of the present invention;

FIG. 2 is a perspective view of the frictional engagement device according to the first embodiment, as from the cutout side of the piston;

FIG. 3 is a top view of a spring assembly in the frictional engagement device according to the first embodiment;

FIG. 4 is a partial cross-sectional view of an automatic transmission including the frictional engagement device according to the first embodiment;

FIG. 5 is a main-portion cross-sectional view showing a pressure receiving portion in a first pressure receiving section of a piston and its vicinity in the frictional engagement device according to the first embodiment;

FIG. 6 is a schematic cross-sectional view showing a frictional engagement device for an automatic transmission according to a second embodiment of the present invention; and

FIG. 7 is a schematic cross-sectional view showing a frictional engagement device for an automatic transmission according to a third embodiment of the present invention.

### DETAILED DESCRIPTION OF THE EMBODIMENTS

In the following description and the accompanying drawings, the present invention will be described in more detail with reference to example embodiments.

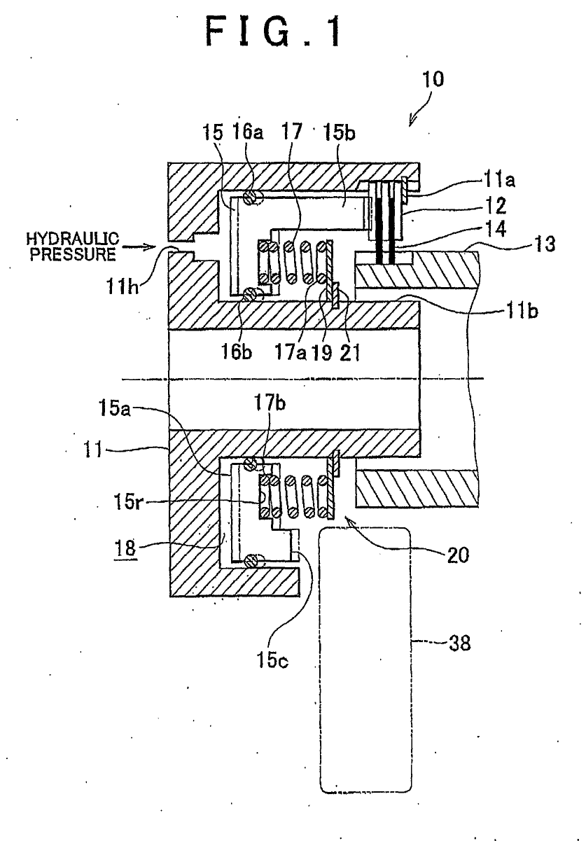

First, a first embodiment of the present invention will be described. FIGS. 1 to 5 are views showing a frictional engagement device for an automatic transmission according to the first embodiment of the present invention, illustrating a case in which the present invention is applied to a wet multiplate brake of an automatic transmission.

First, the configuration of the frictional engagement device will be described. As shown in the schematic cross-sectional view of FIG. 1, a frictional engagement device 10 according to this embodiment includes a tubular case 11 provided within the case of an automatic transmission, plural friction members 12 on one side that are spline-fitted with the inner peripheral portion on one end side (right-end side in FIG. 1) of the case 11 to be supported on the case 11 in a manner displaceable in the axial direction and integrally in the rotational direction, a friction member 14 on the other side that is supported on a rotary element 13, which is provided within the case of the automatic transmission, in a manner displaceable in the axial direction and integrally in the rotational direction, an annular piston 15 to which oil seal rings 16a, 16b are attached and which is slidably accommodated in the case 11, and plural return springs 17 formed by compression coil springs that are interposed between the case 11 and the piston 15 so as to urge the piston 15 to the left side (the other axial side) in FIG. 1.

Displacement of the plural friction members 12 on one side toward one axial side is regulated at a predetermined position by a stopper 11a provided in the case 11. The friction members 12 on one side and the friction member 14 on the other side are alternately arranged so that the friction member 14 on the other side is sandwiched by the plural friction members 12 on one side. The rotary element 13 forms a part of the power transmission path within the automatic transmission (details of which will be described later).

The piston 15 includes a pressure receiving portion 15a and a pressing portion 15b. The pressure receiving portion 15a defines an annular hydraulic chamber 18 between it and the case 11. The pressing portion 15b presses one of the plural frictional plates 12 on one side located closest to the piston 15 toward the one axial side so as to bring the friction members 12 on one side and the friction member 14 on the other side into frictional engagement with each other by the thrust force from the pressure receiving portion 15a. Further, in the case 11, there is defined an oil groove 11h for introducing a hydraulic fluid pressure from a hydraulic control valve such as a linear solenoid valve (not shown) to a hydraulic chamber 18. In the frictional engagement device 10, when the hydraulic pressure in the hydraulic chamber 18 is high, the piston 15 presses the friction members 12 on one side and the friction member 14 on the other side into press contact with each other, thus achieving a predetermined frictional engagement state. When the hydraulic pressure in the hydraulic chamber 18 is low, the frictional engagement between the friction members 12 on one side and the friction member 14 is released. Since such a frictional engagement operation and its release operation are the same as those in the related art, a detailed description will not be given in this regard.

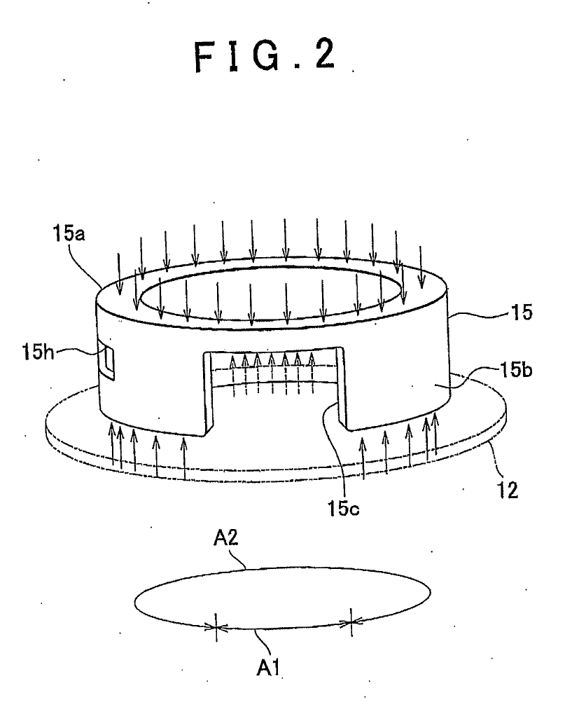

As shown in FIG. 2, the piston 15 has a cutout 15c formed by cutting out the pressing portion 15b over a predetermined angular range. Thus, the piston 15 has a first pressure receiving section A1 where the cutout 15c is formed on the pressing portion 15b side, and a second pressure receiving section A2 other than the first pressure receiving section A1.

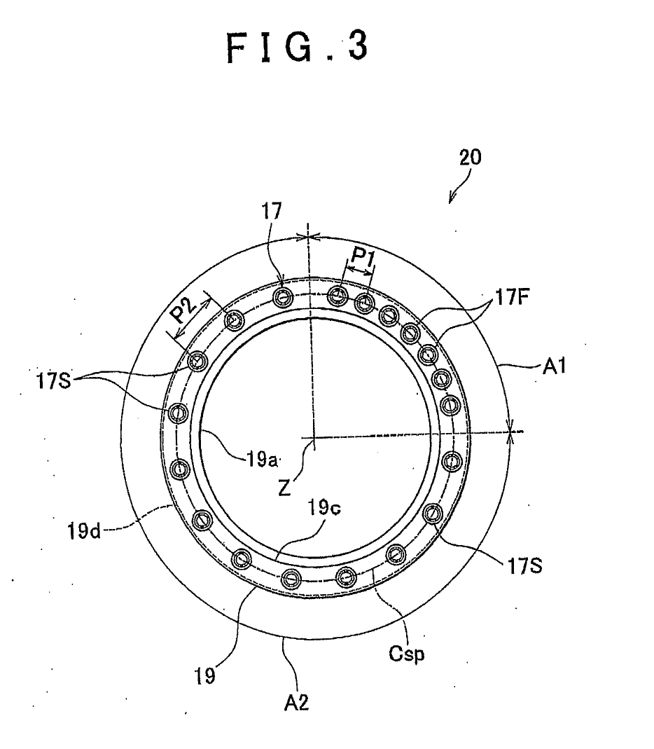

When the piston 15 presses the friction members 12 on one side and the friction member 14 on the other side, the urging force of the return springs 17 per unit angular range in the first pressure receiving section A1 (the sum of loads generated by plural first return springs 17F divided by an angle equivalent to the central angle of the first pressure receiving section A1) is greater than the urging force of the return springs 17 per unit angular range in the second pressure receiving section A2 (the sum of loads generated by plural second return springs 17S divided by an angle equivalent to the central angle of the second pressure receiving section A2). Specifically, as shown in FIG. 3, the plural return springs 17 are arranged at intervals on a circumference Csp of a predetermined radius centered at the central axis of rotation Z of the rotary element 13. The number of the return springs 17 arranged per unit angular range within the first pressure receiving section A1 is larger than the number of the return springs 17 arranged per unit angular range within the second pressure receiving section A2. That is, the arrangement interval between the return springs 17 (hereinafter, also referred to as return springs 17F) arranged within the first pressure receiving section A1 is narrower than the arrangement interval between the return springs 17 (hereinafter, also referred to as return springs 17S) arranged within the second pressure receiving section A2.

Also, the return springs 17 are placed more densely near the central portion of the first pressure receiving section A1 than at the opposite ends of the first pressure receiving section A1 in the circumferential direction of the piston 15, and are spaced by a predetermined gap (for example, approximately equivalent to the diameter of the return springs 17) from the edges at the opposite ends of the cutout 15c formed on the pressing portion 15b side of the piston 15.

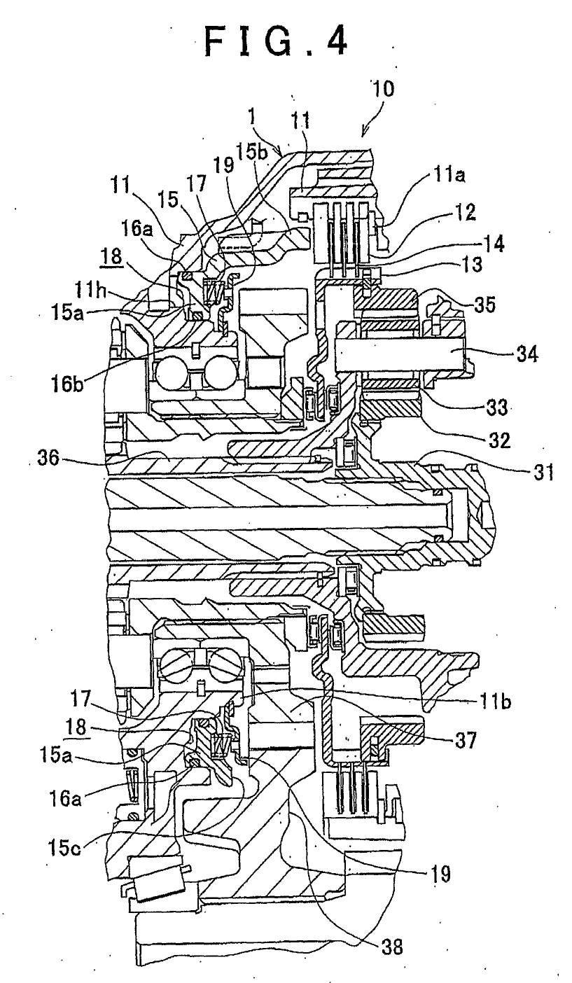

More specifically, the frictional engagement device 10 according to this embodiment is provided inside a gear change mechanism of the automatic transmission as shown in the partial cross-sectional view of FIG. 4. While this gear change mechanism is formed by a gear train of a planetary gear type including plural gear sets, FIG. 4 shows only a first planetary gear set and the vicinity thereof. The gear change mechanism shown in FIG. 4 includes a transmission input shaft 31 to which rotation from a turbine runner (not shown) is inputted, a sun gear 32 spline-coupled to the transmission input shaft 31, plural pinions 33 provided around the sun gear 32, a carrier 34 that can rotate on its axis and holds the plural pinions 33 at equal circumferential intervals in a state with the plural pinions 33 meshed with the sun gear 32, and a ring gear 35 that surrounds the plural pinions 33 so as to mesh with the plural pinions 33 and is supported on the rotary element 13.

As described above, when the friction members 12 on one side and friction member 14 on the other side of the frictional engagement device 10 are brought into frictional engagement with each other, the rotary element 13 is fastened to the case 1 of the automatic transmission by the frictional engagement device 10 that functions as a brake. Therefore, the rotation of the ring gear 35 is restricted by restraint from the case 1 of the automatic transmission selectively via the rotary element 13 and the frictional engagement device 10.

When the rotation of the ring gear 35 is restrained, the pinions 33 rotate on their axes or revolve around the sun gear 32 inside the ring gear 35 in accordance with the rotation of the sun gear 32 that has received an input of rotation from the transmission input shaft 31, and the carrier 34 reduces the speed of the input rotation by a predetermined reduction ratio and outputs the resulting rotation to a rotary shaft 36 on the second planetary gear set side.

When the frictional engagement state of the frictional engagement device 10 is released and the ring gear 35 becomes rotatable, due to the rotation of the ring gear 35, the rotating speed of the pinions 33 with respect to the rotation inputted to the transmission input shaft 31 decreases and the revolving speed of the pinions 33 increases, so the rotational speed outputted from the carrier 34 to the rotary shaft 36 on the second planetary gear set side increases. This operation of the gear change mechanism of a planetary gear type itself is the same as that known in the related art.

A counter drive gear 37 serving as an output element to the drive wheel side (not shown) is arranged inside the piston 15. A counter driven gear 38 for meshing engagement with the counter drive gear 37 meshes with the counter drive gear 37 through the cutout 15c of the piston 15. An opening hole 15h (see FIG. 2) is formed in a part of the peripheral wall of the piston 15. A rotational speed sensor (not shown) that extends through the opening hole 15h and detects the rotational speed of the counter drive gear 37 is inserted in the piston 15.

On the other hand, as shown in FIGS. 1 and 4, the frictional engagement device 10 includes an annular retainer plate 19 that retains one end 17a of the plural return springs 17 on its one side and is locked onto the case 11 by a stopper 21. Also, on the back side of the pressure receiving portion 15a of the piston 15, there is formed a recess 15r into which the other end 17b of the plural return springs 17 retained by the retainer plate 19 is fitted.

The plural return springs 17 retained by the retainer plate 19 are, for example, plural compression springs of the same specifications which have the same natural length and spring constant. The plural return spring 17 and the retainer plate 19 as a whole constitute a single spring assembly 20.

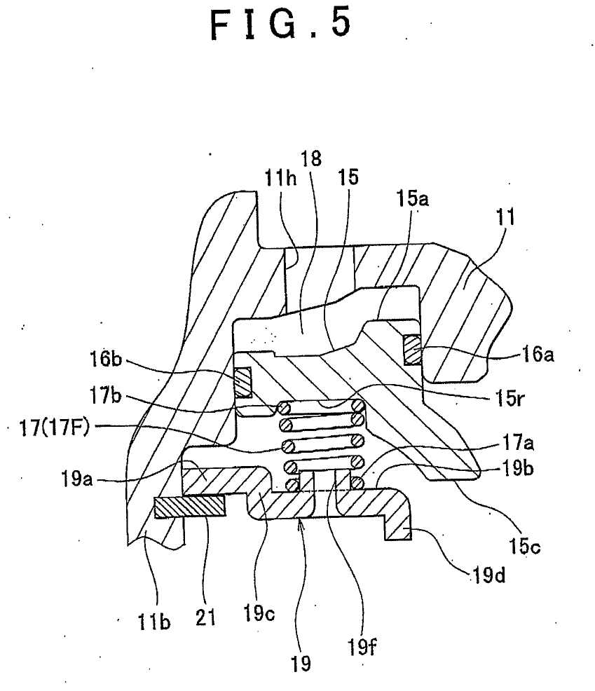

As shown in FIG. 5, the retainer plate 19 has an inner peripheral portion 19a supported on the outer periphery of a boss portion 11b of the case 11, an annular seat surface portion 19b on which one end of the plural return springs 17 abut, an annular stepped portion 19c located in close proximity to the inner periphery of the seat surface portion 19b and between the seat surface portion 19b and the inner peripheral portion 19a of the retainer plate 19, and an annular outer peripheral bent portion 19b located in close proximity to the outer periphery of the seat surface portion 19b. The inner peripheral portion 19a of the retainer plate 19 is prevented from detachment by the stopper 21 attached to the boss portion 11b of the case 11.

The retainer plate 19 has plural projections 19f used for positioning and retention that enter the inner periphery at the one end 17a of the plural return springs 17. The projections 19f are formed at unequal intervals in the circumferential direction of the annular retainer plate 19. That is, the positions of the plural projections 19f are set in such a way that, as described above, the arrangement interval P1 between the return springs 17F arranged within the first pressure receiving section A1 becomes narrower than the arrangement interval P2 between the return springs 17S arranged within the second pressure receiving section A2, and when the piston 15 presses the friction members 12 on one side and the friction member 14 on the other side, the urging force of the return springs 17F per unit angular range in the first pressure receiving section A1 becomes greater than the urging force of the return springs 17S per unit angular range in the second pressure receiving section A2.

Here, the total number and specifications of the plural return springs 17 arranged are determined so as to set the urging force of the plural return springs 17 as a whole to a predetermined value. Further, while in FIG. 3 the first return springs 17F and the second return springs 17S are depicted as being spaced equidistant at predetermined intervals P1 and P2, respectively, the positions of the plural return springs 17 and projections 19f are set at intervals and within ranges that will suppress a moment causing tilting of the piston 15 whenever appropriate.

Next, operation will be described. In the frictional engagement device 10 for an automatic transmission according to this embodiment configured as described above, a predetermined engaging hydraulic pressure is selectively supplied into the hydraulic chamber 18 from the hydraulic control valve (not shown), or the hydraulic pressure is released.

When the engaging hydraulic pressure is supplied into the hydraulic chamber 18, a pressing force is applied to the friction members 12 on one side and the friction member 14 on the other side by the piston 15, thus bringing the friction members 12, 14 into a predetermined frictional engagement state. On the other hand, when the hydraulic pressure in the hydraulic chamber 18 is released, the frictional engagement state between the friction members 12 on one side and the friction member 14 on the other side is released.

Upon such engagement of the frictional engagement device 10, as shown in FIG. 2, in the second pressure receiving section A2 where the pressing portion 15b is present, the piston 15 receives a uniformly distributed load due to the hydraulic pressure from the hydraulic chamber 18 side and a reaction force from the friction members 12, 14 being in press contact with each other. On the other hand, in the first pressure receiving section A1 where the cutout 15c is formed by cutting out a part of the peripheral wall on the pressing portion 15b side of the piston 15 in a substantially U shape, the piston 15 receives a uniformly distributed load due to the hydraulic pressure from the hydraulic chamber 18 side but does not directly receive a reaction force from the friction members 12, 14 being in press contact with each other. Therefore, with the piston and spring design according to the related art, the pressure receiving portion 15a within the first pressure receiving section A1 of the piston 15 is susceptible to deflection or the like.

In contrast, according to this embodiment, the urging force of the return springs 17 per unit angular range in the first pressure receiving section A1 of the piston 15 is greater than the urging force of the return springs 17 per unit angular range in the second pressure receiving section A2, thereby suppressing deformation of the pressure receiving portion 15a in the first pressure receiving section A1.

Further, since the number of the return springs 17 arranged per unit angular range of the first pressure receiving section A1 is larger than the number of the return springs 17 arranged per unit angular range of the second pressure receiving section A2, the urging force of the return springs 17 per unit angular range can be made larger in the first pressure receiving section A1 with ease.

Further, the return springs 17 are placed more densely at the central portion of the first pressure receiving section A1 in the circumferential direction of the piston 15 than at the opposite ends of the first pressure receiving section A1, thereby making it possible to effectively suppress deflection or the like of the pressure receiving section 15a in the first pressure receiving section A1.

In addition, there is provided the annular retainer plate 19 that retains the one end 17a of the plural return springs 17 on its one side and is locked onto the case 11, and on the back side of the pressure receiving portion 15a of the piston 15, there is formed the recess 15r into which the other end 17b of the plural return springs 17 retained by the retainer plate 19 is fitted. Therefore, even when the arrangement intervals of the return springs 17 are not uniform or the return springs 17 used are of different kinds, as the spring assembly 20 having the plural return springs 17 retained by the retainer plate 19, its handling or assembling can be facilitated, and also its assembling onto the piston 15 side becomes easy.

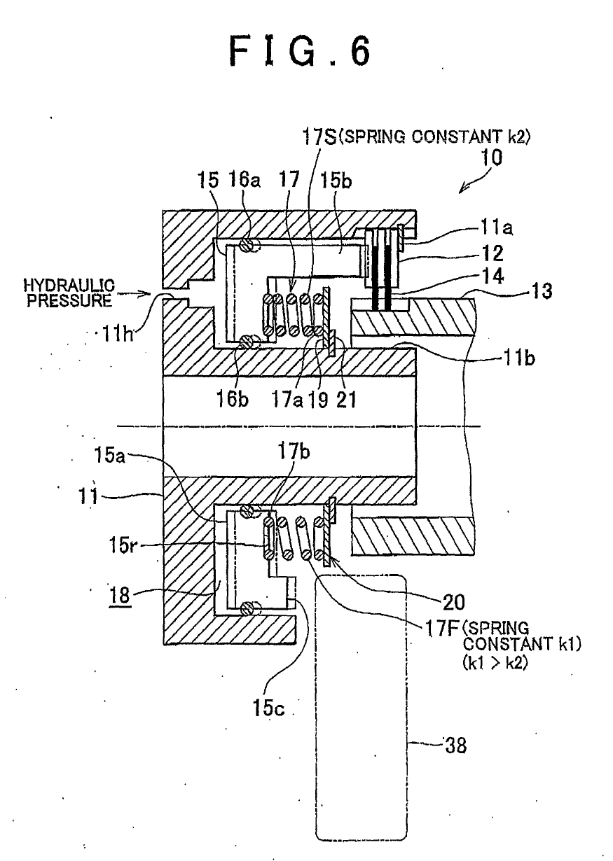

Next, a second embodiment of the present invention will be described. FIG. 6 is a schematic cross-sectional view of a frictional engagement device for an automatic transmission according to the second embodiment of the present invention.

While embodiments described below differ from the above-described first embodiment in the configuration of the spring assembly including the plural return springs and the retainer plate, otherwise, these embodiments are of the same configuration as the first embodiment. Therefore, the same reference numeral as those described above are used to described the same configuration, and the following description will focus solely on differences.

In this embodiment, when the piston 15 presses the friction members 12 on one side and the friction member 14 on the other side into frictional engagement with each other, a generated load F1 of the return springs 17F in the first pressure receiving section A1 is greater than a generated load F2 of the return springs 17S in the second pressure receiving section A2.

Specifically, the first return springs 17F of the plural return springs 17 which are arranged in the first pressure receiving section A1, and the second return springs 17S of the plural return springs 17 which are arranged in the second pressure receiving section A2 have mutually equal lengths and different spring constants k1, k2. The spring constant k1 of the first return springs 17F is larger than the spring constant k2 of the second return springs 17S.

In this case, when the frictional engagement state of the frictional engagement device is released, and the piston 15 is displaced in accordance with an increase in the hydraulic pressure acting on the pressure receiving portion 15a of the piston 15, the generated load of the return springs 17F in the first pressure receiving section A1 becomes gradually larger than the generated load of the return springs 17S in the second pressure receiving section A2. This means that at the time of application of hydraulic pressure for frictional engagement when deformation is liable to occur in the first pressure receiving section A1, the urging force of the return springs 17F is sufficiently enhanced. As a result, it is possible to effectively suppress deformation of the piston 15 such as deflection of the pressure receiving portion 15a in the first pressure receiving section A1. Also, when the piston 15 begins its stroke toward the frictional engagement side with the frictional engagement device 10 in a released state, the urging force exerted by the plural return springs 17 can be made substantially uniform across the entire circumference of the piston 15.

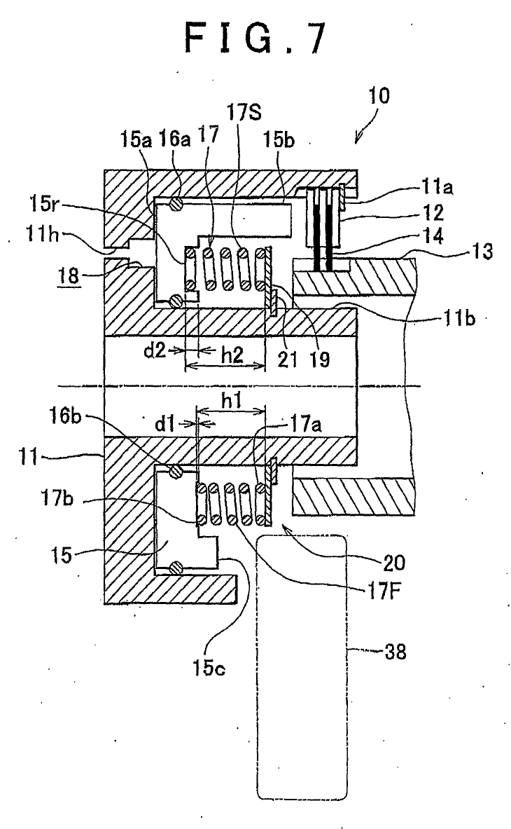

Next, a third embodiment of the present invention will be described. FIG. 7 is a schematic cross-sectional view of a frictional engagement device for an automatic transmission according to the third embodiment of the present invention.

Since this embodiment is of substantially the same configuration as the above-described embodiments, the following description will focus solely on differences by using the same reference numerals as those described above.

In this embodiment, when the piston 15 presses the friction members 12 on one side and the friction member 14 on the other side into frictional engagement with each other, the generated load F1 of the return springs 17F in the first pressure receiving section A1 is greater than the generated load F2 of the return springs 17S in the second pressure receiving section A2.

In the above-described second embodiment, the spring constant is made to differ between the return springs 17F, 17S to produce a difference in spring load generated at the time of frictional engagement. In this embodiment, in contrast, the first return springs 17F of the plural return springs 17 which are arranged in the first pressure receiving section A1, and the second return springs 17S of the plural return springs 17 which are arranged in the second pressure receiving section A2 have the same free length and spring constant k and mutually different installation loads.

In this embodiment, since the return springs 17 are compression coil springs, the installation loads as referred to herein correspond to installation heights h1,

h2. The installation height h refers to the height (length) of each of the return springs 17 attached between the piston 15 and the retainer plate 19 in a state with the hydraulic pressure released.

In this embodiment, for example, the depth of the recess 15r on the back side of the pressure receiving portion 15a into which the other end 17b of the return springs 17 is fitted is set as a small depth d1 in the first pressure receiving section A1, and is set as a large depth d2 larger than the depth d1 in the second pressure receiving section A2, so that the installation height h1 of the first return springs 17F becomes smaller than the installation height h2 of the second return springs 17S. That is, the first return springs 17F are attached between the piston 15 and the retainer plate 19 under greater deflection than the second return springs 17S.

In the frictional engagement device for an automatic transmission according to this embodiment as described above, when the piston 15 presses the friction members 12 on one side and the friction member 14 on the other side, the generated load of the return springs 17F in the first pressure receiving section A1 becomes greater than the generated load of the return springs 17S in the second pressure receiving section A2. It is thus possible to make the urging force of the return springs 17 per unit angular range greater in the first pressure receiving section A1.

Further, in this embodiment, the increased material thickness on the back side of the pressure receiving portion 15a in the first pressure receiving section A1 makes it possible to enhance the strength of the first pressure receiving section A1 of the piston 15.

Further, in this embodiment, the plural return springs 17 can be all made the same parts, thus allowing for ease of handling and reduced cost.

In this embodiment, the depth of the recess 15r on the back side of the pressure receiving portion 15a is set as the small depth d1 in the first pressure receiving section A1 and as the larger depth d2 in the second pressure receiving section A2. However, it is understood that the installation height h1 (installation load) of the first return springs 17F can be made smaller than the installation height h2 (installation load) of the second return springs 17S also by making the shape of the seat surface portion 19b of the retainer plate 19 differ between the first pressure receiving section A1 and the second pressure receiving section A2 while making the depth of the recess 15r on the back side of the pressure receiving portion 15a be the same fixed depth. Further, while the above-described embodiments are directed to a case where cylindrical compression coil springs having a circular cross section are used as the return springs 17, the cross sectional shape may not necessarily be a circular shape, and the shape of the return springs 17 may be any arbitrary shape other than a cylindrical shape, such as a conical shape, drum shape, or barrel shape. Further, the springs used are not limited to compression coil springs but may be disc springs or leaf springs. Further, combination coil springs whose generated load increases when a predetermined piston stroke is attained may be used in the first pressure receiving section, or return springs having a fixed spring constant may be arranged at equal intervals around the entire circumference and other return springs having a different spring constant or installation height may be additionally provided in the first pressure receiving section.

As has been described above, according to the present invention, in the piston 15 to which a hydraulic pressure from the hydraulic chamber 18 side and a reaction force from the friction members 12, 14 side acting opposite thereto are applied in the second pressure receiving section A2, and only the hydraulic pressure from the hydraulic chamber 18 side is applied in the first pressure receiving section A1 where the pressing portion 15b side is cut out, the urging force of the return springs 17 per unit angular range in the first pressure receiving section A1 is made greater than that in the second pressure receiving section A1 to suppress deformation of the pressure receiving portion 15a in the first pressure receiving section A1. This provides the effect of effectively suppressing deformation of the piston 15, such as deflection of the pressure receiving portion 15a in the first pressure receiving section A1. The present invention has utility for frictional engagement devices for an automatic transmission mounted in a vehicle, in particular, for a broad range of frictional engagement devices for an automatic transmission including a piston that is partially cut out on the side of its friction-member pressing portion to prevent interference with another member.

1. A frictional engagement device for an automatic transmission, comprising: a tubular case provided inside the automatic transmission; a friction member on one side that is supported on the case; a friction member on the other side that is supported on a rotary element provided inside the automatic transmission; an annular piston slidably accommodated in the case and having a pressure receiving portion and a pressing portion, the pressure receiving portion defining an annular hydraulic chamber between the pressure receiving portion and the case, the pressing portion pressing the friction member on one side and the friction member on the other side toward one axial side with a thrust force from the pressure receiving portion; and plural return springs interposed between the case and the piston so as to urge the piston toward the other axial side, wherein
the piston has a first pressure receiving section where the pressing portion is cut out over a predetermined angular range in its circumferential direction, and a second pressure receiving section other than the first pressure receiving section, and when the piston presses the friction member on one side and the friction member on the other side, an urging force of the return springs per unit angular range of the first pressure receiving section is greater than an urging force of the return springs per unit angular range of the second pressure receiving section.

2. The frictional engagement device for an automatic transmission according to claim 1, wherein
the number of the return springs arranged per unit angular range of the first pressure receiving section is larger than the number of the return springs arranged per unit angular range of the second pressure receiving section.

3. The frictional engagement device for an automatic transmission according to claim 1, wherein
when the piston presses the friction member on one side and the friction member on the other side, a generated load of the return springs within the first pressure receiving section is greater than a generated load of the return springs within the second pressure receiving section.

4. The frictional engagement device for an automatic transmission according to claim 3, wherein
a first return spring of the plural return springs which is arranged within the first pressure receiving section, and a second return spring of the plural return springs which is arranged within the second pressure receiving section have mutually different spring constants.

5. The frictional engagement device for an automatic transmission according to claim 1, wherein
a first return spring of the plural return springs which is arranged within the first pressure receiving section, and a second return spring of the plural return springs which is arranged within the second pressure receiving section have the same spring constant and mutually different installation loads.

6. The frictional engagement device for an automatic transmission according to claim 1, wherein
the return springs are arranged more densely at a central portion of the first pressure receiving section than at opposite ends of the first pressure receiving section in a circumferential direction of the piston.

7. The frictional engagement device for an automatic transmission according to claim 1, wherein
the frictional engagement device further comprises an annular retainer plate that retains one end of the plural return springs on its one side and is locked onto the case, and a recess into which the other end of the plural return springs retained by the retainer plate is fitted is formed on a back side of the pressure receiving portion of the piston.

8. The frictional engagement device for an automatic transmission according to claim 7, wherein
a depth of the recess provided on the back side of the pressure receiving portion of the piston is smaller in the first pressure receiving section than in the second pressure receiving section.

9. The frictional engagement device for an automatic transmission according to claim 7, wherein
a surface of the retainer plate which retains the plural return springs is shaped so as to be closer to the return springs at a position corresponding to the first pressure receiving section than at a position corresponding to the second pressure receiving section.

10. The frictional engagement device for an automatic transmission according to claim 2, wherein
when the piston presses the friction member on one side and the friction member on the other side, a generated load of the return springs within the first pressure receiving section is greater than a generated load of the return springs within the second pressure receiving section.

11. The frictional engagement device for an automatic transmission according to claim 2, wherein
a first return spring of the plural return springs which is arranged within the first pressure receiving section, and a second return spring of the plural return springs which is arranged within the second pressure receiving section have the same spring constant and mutually different installation loads.

12. The frictional engagement device for an automatic transmission according to claim 2, wherein
the return springs are arranged more densely at a central portion of the first pressure receiving section than at opposite ends of the first pressure receiving section in a circumferential direction of the piston.

13. The frictional engagement device for an automatic transmission according to claim 2, wherein
the frictional engagement device further comprises an annular retainer plate that retains one end of the plural return springs on its one side and is locked onto the case, and a recess into which the other end of the plural return springs retained by the retainer plate is fitted is formed on a back side of the pressure receiving portion of the piston.

14. The frictional engagement device for an automatic transmission according to claim 3, wherein
a first return spring of the plural return springs which is arranged within the first pressure receiving section, and a second return spring of the plural return springs which is arranged within the second pressure receiving section have the same spring constant and mutually different installation loads.

15. The frictional engagement device for an automatic transmission according to claim 3, wherein
the return springs are arranged more densely at a central portion of the first pressure receiving section than at opposite ends of the first pressure receiving section in a circumferential direction of the piston.

16. The frictional engagement device for an automatic transmission according to claim 3, wherein
the frictional engagement device further comprises an annular retainer plate that retains one end of the plural return springs on its one side and is locked onto the case, and a recess into which the other end of the plural return springs retained by the retainer plate is fitted is formed on a back side of the pressure receiving portion of the piston.
